(19) United States
(12) Patent Application Publication
(10) Pub. No.: US 2026/0166657 A1
(43) Pub. Date: Jun. 18, 2026

(54) MULTI-DEGREE-OF-FREEDOM ULTRASONIC-ASSISTED LASER CLADDING REMANUFACTURING DEVICE AND WORKING METHOD THEREOF

(71) Applicant: Hefei University of Technology, Hefei (CN)

(72) Inventors: Kaiyuan Peng, Hefei (CN); Qianpeng Luo, Hefei (CN); Haihong Huang, Hefei (CN); Jiangtao Hu, Hefei (CN); Chaoming Wang, Hefei (CN)

(21) Appl. No.: 19/397,867

(22) Filed: Nov. 22, 2025

(30) Foreign Application Priority Data
Dec. 17, 2024 (CN) 2024118550368

(51) Int. Cl. B23K 26/70

(52) U.S. Cl. CPC B23K 26/703

(57) ABSTRACT

A multi-degree-of-freedom ultrasonic-assisted laser cladding remanufacturing device includes a worktable, a workpiece to be processed disposed at a top end of the worktable by a positioning mechanism, a laser cladding mechanism disposed above the workpiece to be processed, and focused ultrasonic vibration mechanisms symmetrically arranged on two sides of the laser cladding mechanism by multi-degree-of-freedom variable-angle clamping mechanisms. The focused ultrasonic vibration mechanisms are configured to emit focused ultrasonic waves aligned with a cladding zone of the laser cladding mechanism. The high-intensity focusing of ultrasonic waves is achieved through a multi-stage focusing method, which can uniformly apply ultrasonic vibration during laser irradiation. This effectively reduces defects such as cracks and pores, thereby improving the processing quality and efficiency of laser cladding remanufacturing.

### CROSS-REFERENCE TO RELATED APPLICATION

This application claims priority to Chinese patent application No. 202411855036.8, filed to China National Intellectual Property Administration (CNIPA) on Dec. 17, 2024, which is herein incorporated by reference in its entirety.

### TECHNICAL FIELD

The disclosure relates to the field of laser cladding technologies, and particularly to a multi-degree-of-freedom ultrasonic-assisted laser cladding remanufacturing device and a working method thereof.

### BACKGROUND

Laser cladding technologies, as cutting-edge surface modification technologies, have demonstrated broad application prospects in various industries due to its unique advantages. By utilizing a high energy laser beam, it can precisely deposit specific materials onto a substrate surface, achieving localized material addition, repair, or reconstruction. In particular, the application of laser cladding technology stands out in the fields of aerospace, automotive manufacturing, building materials, and energy.

Laser cladding technology has the following technical characteristics and advantages: 1. High efficiency and precision: Laser cladding technology can achieve high precision control of materials, whether for addition or repair, to achieve the desired effect. 2. Flexibility and innovation: Combined with additive manufacturing technology, laser cladding remanufacturing technology shows great flexibility and innovation. 3. Environmental protection and economy: Through remanufacturing technology, not only can damaged or aged parts be repaired, but the service life of equipment can also be significantly extended, saving a large amount of materials and precious metals, and reducing production costs.

Thanks to the above advantages, it has the following application examples: 1. Surface strengthening: In industries such as mining machinery, petrochemicals, and power, many key components wear out due to long term use. Through laser cladding technology, a layer of high performance alloy material can be formed on the surface of these components to improve their surface hardness and wear resistance, and extend their service life. 2. Repair and remanufacturing: For workpieces that have failed due to wear or other reasons, laser cladding technology can achieve surface repair and performance enhancement, restoring them to or even surpassing their original state.

However, laser cladding technology still faces the following challenges: 1. Cracks and pores: During the cladding process, rapid cooling and high temperature gradients can easily lead to the formation of cracks and pores, which can affect the quality of the cladding layer and even damage the performance of the substrate material. 2. Limitations of ultrasonic vibration assisted technology: Although existing ultrasonic vibration assisted laser cladding technology has improved the quality of the cladding layer to some extent, there are still issues such as insufficient degrees of freedom, low ultrasonic energy transfer efficiency, poor focusing effect, and uneven ultrasonic application, which limit the wide application of the technology.

### SUMMARY

The purpose of the embodiments of the disclosure is to provide a multi-degree-of-freedom ultrasonic-assisted laser cladding remanufacturing device and a working method thereof to solve above issues.

To achieve above purpose, the disclosure provides a multi-degree-of-freedom ultrasonic-assisted laser cladding remanufacturing device, and the technical solutions of the disclosure are as follows.

The multi-degree-of-freedom ultrasonic-assisted laser cladding remanufacturing device includes a worktable, a workpiece to be processed configured to be disposed on a top end of the worktable by a positioning mechanism, a laser cladding mechanism disposed above the workpiece to be processed, and focused ultrasonic vibration mechanisms symmetrically arranged on two sides of the laser cladding mechanism by multi-degree-of-freedom variable-angle clamping mechanisms. The focused ultrasonic vibration mechanisms being configured to emit focused ultrasonic waves aligned with a cladding zone of the laser cladding mechanism.

In an embodiment, each of the focused ultrasonic vibration mechanisms includes an ultrasonic generator, the ultrasonic transducer, a focusing amplitude transformer, and a diffraction-focused acoustic lens sequentially arranged in that order. The ultrasonic generator is electrically connected to the ultrasonic transducer, an emitting end of the ultrasonic transducer is aligned with an end of the focusing amplitude transformer, another end of the focusing amplitude transformer is configured as a concave focusing head, the concave focusing head is concentrically arranged with the diffraction-focused acoustic lens, and the diffraction-focused acoustic lens is fixedly connected to the ultrasonic transducer through connecting rods. The diffraction-focused acoustic lens includes alternating transparent rings and concentrically arranged transparent rings and opaque rings.

In an embodiment, each of the multi-degree-of-freedom variable-angle clamping mechanisms includes a three-directional displacement platform, an angle adjustment unit arranged on an output end of the three-directional displacement platform, and a clamp ring connected to an output end of the angle adjustment unit. The clamp ring is engaged with an outer wall of an ultrasonic transducer.

In an embodiment, the three-directional displacement platform includes an X-direction adjustment assembly, a Y-direction adjustment assembly, and a Z-direction adjustment assembly connected in sequence in that order, and each of the X-direction adjustment assembly, the Y-direction adjustment assembly, and the Z-direction adjustment assembly includes a base and a slide plate t slidably mounted on the base; a rack is fixedly mounted on a side of the base facing towards the slide plate, a displacement adjustment gear meshing with the rack is rotatably mounted on the slide plate, a shaft of the displacement adjustment gear is connected to a displacement adjustment handwheel rotatably mounted on the slide plate, and the slide plate is positioned and connected to the base through a positioning bolt. The base of the X-direction adjustment assembly is connected to the laser cladding mechanism through a connecting plate, and the slide plate of the Z-direction adjustment assembly is connected to the angle adjustment unit.

In an embodiment, the angle adjustment unit includes a pitch angle adjustment assembly and a horizontal angle adjustment assembly. The pitch angle adjustment assembly includes a pitch angle adjustment gear vertically rotatably mounted on the slide plate of the Z-direction adjustment assembly, and a pitch angle adjustment handwheel meshing with the pitch angle adjustment gear. The pitch angle adjustment handwheel is rotatably mounted on a regulating plate, and an end of the regulating plate facing towards the slide plate of the Z-direction adjustment assembly is fixed with a slide head; the slide head is slidably connected to an arc-shaped slide slot defined on the slide plate of the Z-direction adjustment assembly, and the arc-shaped slide slot is concentrically arranged with the pitch angle adjustment gear. The horizontal angle adjustment assembly comprises a horizontal angle adjustment handwheel rotatably mounted on the regulating plate, the horizontal angle adjustment handwheel is penetrated into an interior of the regulating plate and connected with a worm wheel, the worm wheel meshes with an end of a worm shaft rotatably mounted inside the regulating plate, and another end of the worm shaft is fixedly connected with the clamp ring. The regulating plate and the slide plate of the Z-direction adjustment assembly, as well as the worm shaft and the regulating plate, are positioned and connected through positioning set screws.

In an embodiment, the multi-degree-of-freedom ultrasonic-assisted laser cladding remanufacturing device further includes a cooling mechanism. The cooling mechanism includes a cooling water tank and a circulation pump, an outlet pipe of the cooling water tank is connected to the circulation pump, a heat exchange tube is connected to the circulation pump and in contact with the ultrasonic transducer of each of the focused ultrasonic vibration mechanism and the laser cladding mechanism, individually, and the heat exchange tube is further connected to the circulation pump through a return water port.

In an embodiment, the heat exchange tube is connected to a water cooling plate attached onto the diffraction-focused acoustic lens through a water pipe, the water cooling plate is a structure of multi-layer annular water-cooled coils, with adjacent layers of annular water-cooled coils are connected by communication pipes, and the multi-layer annular water-cooled coils are fixedly connected to a side of the opaque rings of the diffraction-focused acoustic lens facing towards the cladding zone. The multi-layer annular water-cooled coils are concentrically arranged with the diffraction-focused acoustic lens, and an inner diameter of an innermost layer of annular water-cooled coil of the multi-layer annular water-cooled coils is not less than a lowest diffraction radius of the diffraction-focused acoustic lens.

In an embodiment, a material of the transparent rings of the diffraction-focused acoustic lens is polyimide.

In an embodiment, the positioning mechanism includes positioning cylinders arranged around the workpiece to be processed, and positions of the positioning cylinders facing towards the workpiece to be processed are fixed with positioning plates, respectively.

A working method of the multi-degree-of-freedom ultrasonic-assisted laser cladding remanufacturing device includes steps S1 to S3 as follows.

S1, loading: the workpiece to be processed is placed on the worktable, and the positioning cylinders are activated to drive the positioning plates to hold edges of the workpiece to be processed.

S2, position adjusting: the displacement adjustment gears on the X-direction adjustment assembly, the Y-direction adjustment assembly and the Z-direction adjustment assembly are sequentially rotated, under meshing actions with the respective racks, to drive the slide plates of the X-direction adjustment assembly, the Y-direction adjustment assembly and the Z-direction adjustment assembly to slide along the respective bases of the X-direction adjustment assembly, the Y-direction adjustment assembly, and the Z-direction adjustment assembly, thereby adjusting a position of the ultrasonic transducer of each of the focused ultrasonic vibration mechanism to make two the ultrasonic transducers be symmetrical about the laser cladding mechanism. Then, the positioning bolts are used to position current position of the ultrasonic transducer. Afterwards, the pitch angle adjustment handwheel is rotated to drive the regulating plate to rotate around the pitch angle adjustment gear, thereby adjusting a pitch angle of the ultrasonic transducer. Next, the horizontal angle adjustment handwheel is rotated to drive the ultrasonic transducer to rotate under an action of the worm wheel and the worm shaft, thereby ensuring that the ultrasonic waves emitted by the ultrasonic transducer, after being amplified by the focusing amplitude transformer, propagate towards a center of the diffraction-focused acoustic lens to thereby be focused onto the cladding zone by the diffraction-focused acoustic lens. Finally, the positioning set screws are used to position a current position of the ultrasonic transducer.

S3, the circulation pumps of the cooling mechanism and the laser cladding mechanism are sequentially activated to simultaneously cool the ultrasonic transducers, the laser cladding mechanism, and the diffraction-focused acoustic lenses with cooling water. The laser cladding mechanism is activated, a laser emitted is aimed by a laser cladding head of the laser cladding mechanism at the cladding zone, and powder supplied by a powder feeder of the laser cladding mechanism is delivered to the cladding zone. The powder is melted under a combined action of the laser and ultrasonic assistance and the cladding zone of the workpiece to be processed is covered.

The beneficial effects of the disclosure are as follows.

1. The multi-stage focusing mechanism works together to achieve precise and high-intensity focusing of ultrasonic energy, significantly increasing an energy density in the cladding zone, which is conducive to obtaining higher quality processing results. In addition, by reducing energy loss and ineffective radiation, the utilization efficiency of ultrasonic energy is improved, energy consumption is reduced, processing efficiency is increased, and thus it can be widely used in laser cladding remanufacturing of various materials, especially in fields with high requirements for remanufacturing processing quality, such as aerospace, automotive manufacturing, and precision machinery.

2. Ultrasonic vibration can be precisely focused on a molten pool. Thermal effect, cavitation effect, and acoustic streaming effect produced by the ultrasonic focus can promote the formation of nuclei and the fluidity of liquid metal, making the microstructure more uniform and the structure more compact. This improves the strength and wear resistance of the remanufactured cladding layer, thereby enhancing the quality and efficiency of laser cladding remanufacturing processing.

3. The symmetrical arrangement of two focused ultrasonic vibration mechanisms achieves broader coverage and more uniform application of ultrasonic energy, while reducing energy attenuation and improving the ultrasonic effect. This avoids the problem of energy attenuation encountered by a single ultrasonic vibration mechanism during energy transmission. It can more effectively control the microstructure of the remanufactured cladding layer. Multi-dimensional ultrasonic vibration can influence the growth direction and morphology of grains, thereby achieving finer microstructural control. The non-linear effect plays an important role in suppressing defects in the cladding layer, such as cracks and pores. Stronger cavitation and acoustic streaming effects can more effectively stir the molten pool, promote the discharge of gases, and ensure the uniform distribution of nuclei. Through a more efficient defect suppression mechanism, the number of defects in the remanufactured cladding layer can be reduced, and the quality and reliability of the cladding layer can be improved.

4. The two focused ultrasonic vibration mechanisms can serve as backups for each other, thereby reducing the impact of downtime on production.

5. Enhanced adaptability: the multi-degree-of-freedom variable-angle clamping mechanisms can flexibly adjust the position and angle of the focus ultrasonic vibration mechanisms in three-dimensional space, increasing the versatility of the device.

6. Improved processing efficiency: high-intensity focused ultrasonic assistance promotes stirring of the molten pool and uniform distribution of materials, increasing heating efficiency and cladding speed, thereby reducing processing costs.

7. Easy to optimize and expand: the structure of the diffraction-focused acoustic lens is simple and easy to optimize for design. It can adapt to sound waves of different frequencies to meet the needs of various application scenarios.

The technical solution of the present invention will be further described in detail through the accompanying drawings and embodiments.

### BRIEF DESCRIPTION OF DRAWINGS

FIG. 1 illustrates an overall schematic structural diagram of a multi-degree-of-freedom ultrasonic-assisted laser cladding remanufacturing device of the disclosure.

FIG. 2 illustrates a front view of a multi-degree-of-freedom variable-angle clamping mechanism of the multi-degree-of-freedom ultrasonic-assisted laser cladding remanufacturing device in the disclosure.

FIG. 3 illustrates an exploded view of the multi-degree-of-freedom variable-angle clamping mechanism of the multi-degree-of-freedom ultrasonic-assisted laser cladding remanufacturing device in the disclosure

FIG. 4 illustrates a schematic structural diagram of a focused ultrasonic vibration mechanism of the multi-degree-of-freedom ultrasonic-assisted laser cladding remanufacturing device in the disclosure.

FIG. 5 illustrates a schematic structural diagram of a diffraction-focused acoustic lens of the multi-degree-of-freedom ultrasonic-assisted laser cladding remanufacturing device in the disclosure.

FIG. 6 illustrates another schematic structural diagram of the diffraction-focused acoustic lens of the multi-degree-of-freedom ultrasonic-assisted laser cladding remanufacturing device in the disclosure.

FIG. 7 illustrates a schematic structural diagram of a cooling mechanism of the multi-degree-of-freedom ultrasonic-assisted laser cladding remanufacturing device in the disclosure.

### DESCRIPTION OF REFERENCE NUMERALS

1. worktable; 2. ultrasonic transducer; 3. focusing amplitude transformer; 31. concave focusing head; 4. diffraction-focused acoustic lens; 41. transparent ring; 42. opaque ring; 401. connecting rod; 5. laser cladding mechanism; 6. Y-direction adjustment assembly; 7. X-direction adjustment assembly; 8. Z-direction adjustment assembly; 9. pitch angle adjustment assembly; 10. horizontal angle adjustment assembly; 11. positioning cylinder; 12. workpiece to be processed; 13. ultrasonic generator; 17. pitch angle adjustment gear; 18. pitch angle adjustment handwheel; 19. horizontal angle adjustment handwheel; 20. regulating plate; 21. worm shaft; 22. clamp ring; 23. water-cooling plate; 231. communication pipe; 232. multi-layer annular water-cooled coil; 24. worm wheel; 25. positioning set screw; 201. slide head; 30. focused ultrasonic vibration mechanism; 40. multi-degree-of-freedom variable-angle clamping mechanism; 50. cooling mechanism; 51. cooling water tank; 52. circulation pump; 53. outlet pipe; 54. heat exchange tube; 55. return water port; 61. slide plate of Y-direction adjustment assembly; 62. base of Y-direction adjustment assembly; 63. rack of Y-direction adjustment assembly; 64. displacement adjustment gear of Y-direction adjustment assembly; 65. shaft of Y-direction adjustment assembly; 66. displacement adjustment handwheel of Y-direction adjustment assembly; 71. slide plate of X-direction adjustment assembly; 72. base of X-direction adjustment assembly; 73. rack of X-direction adjustment assembly; 74. displacement adjustment gear of X-direction adjustment assembly; 75. shaft of X-direction adjustment assembly; 76. displacement adjustment handwheel of X-direction adjustment assembly; 77. positioning bolt; 78. connecting plate; 81. slide plate of Z-direction adjustment assembly; 82. base of Z-direction adjustment assembly; 83. rack of Z-direction adjustment assembly; 84. displacement adjustment gear of Z-direction adjustment assembly; 85. shaft of Z-direction adjustment assembly; 86. displacement adjustment handwheel of Z-direction adjustment assembly; 801. arc-shaped slide slot.

### DETAILED DESCRIPTION OF EMBODIMENTS

In the description of the disclosure, it should be noted that the directional or positional relationships indicated by the terms “up”, “down”, “inside”, “outside”, etc. are based on the directional or positional relationships shown in the attached drawings, or the directional or positional relationships commonly used when the product of the disclosure is used. This is only for the convenience of describing the disclosure and simplifying the description, and does not indicate or imply that the device or component referred to must have a specific orientation, be constructed and operated in a specific orientation, and therefore cannot be understood as a limitation of the disclosure. In the description of the disclosure, it should be noted that unless otherwise specified and limited, the terms “set”, “install”, and “connect” should be broadly understood, for example, they can be fixed connections, detachable connections, or integrated connections; It can be a mechanical connection or an electrical connection; It can be directly connected, indirectly connected through an intermediate medium, or connected internally between two components. For those skilled in the art, the specific meanings of the above terms in the disclosure can be understood in specific situations.

A detailed explanation of the embodiments of the disclosure will be provided in conjunction with the attached drawings as follows.

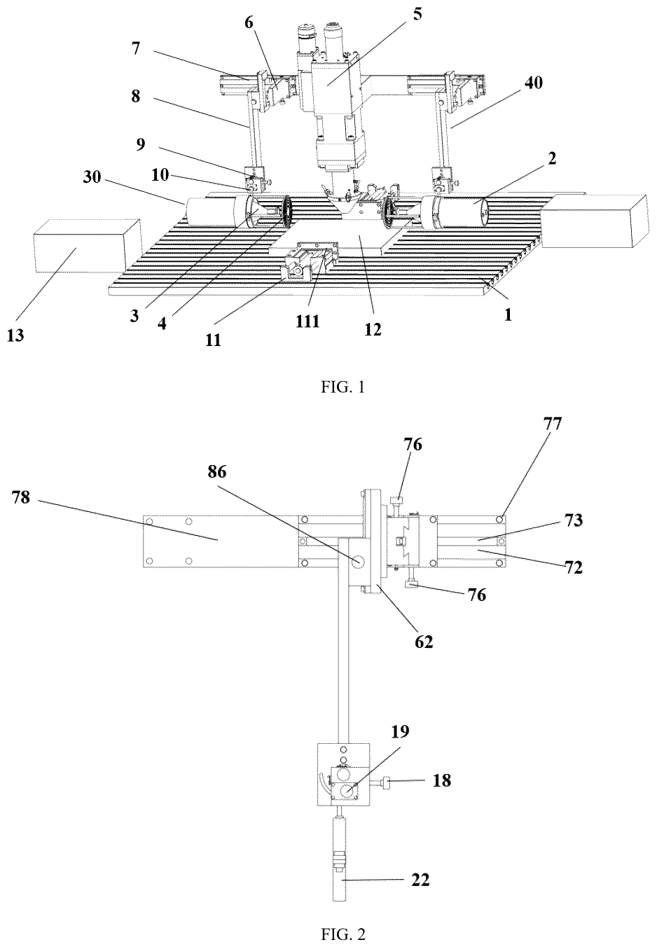

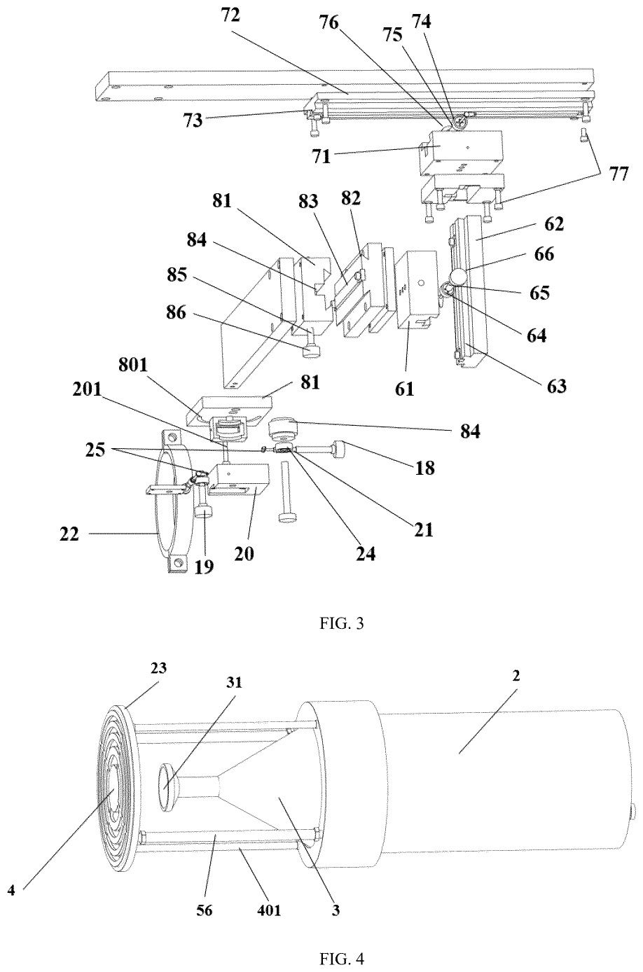

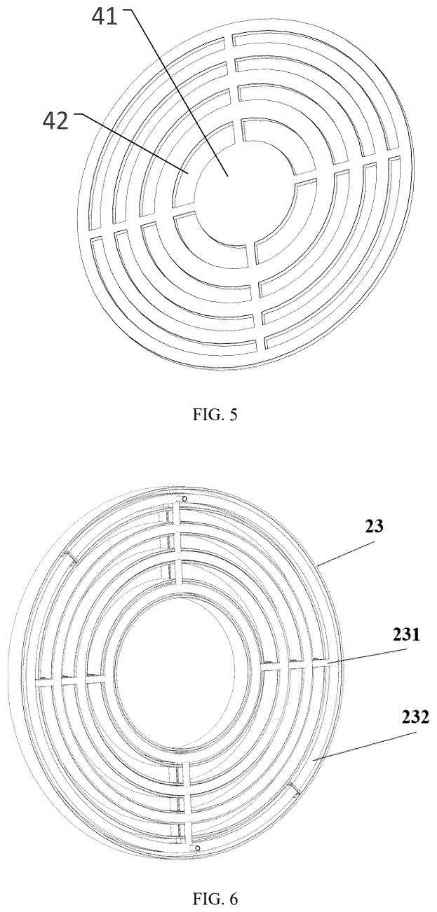

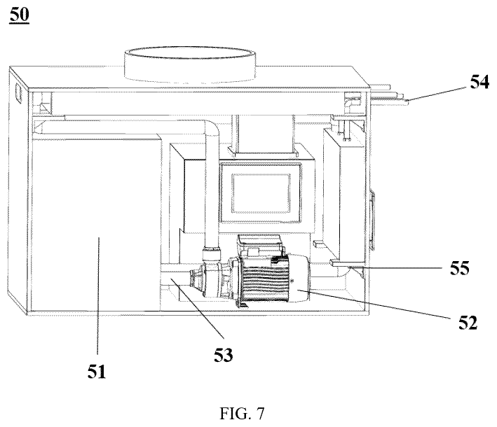

As shown in FIGS. 1-7, the multi-degree-of-freedom ultrasonic-assisted laser cladding remanufacturing device includes a worktable 1, a workpiece to be processed 12 disposed on a top end of the worktable1 by a positioning mechanism, a laser cladding mechanism 5 disposed above the workpiece to be processed 12, and focused ultrasonic vibration mechanisms 30 symmetrically arranged on two sides of the laser cladding mechanism 5 by multi-degree-of-freedom variable-angle clamping mechanisms 40. The focused ultrasonic vibration mechanisms 30 are configured to emit focused ultrasonic waves aligned with a cladding zone of the laser cladding mechanism 5.

Each of the focused ultrasonic vibration mechanisms 30 includes an ultrasonic generator 13, an ultrasonic transducer 2, a focusing amplitude transformer 3, and a diffraction-focused acoustic lens 4 sequentially arranged in that order. The ultrasonic generator 13 is electrically connected to the ultrasonic transducer 2, an emitting end of the ultrasonic transducer 2 is aligned with an end of the focusing amplitude transformer 3, another end of the focusing amplitude transformer 3 is configured as a concave focusing head 31 (a concave structure not only improves the focusing ability, but also reduces reflection and loss of energy during transmission through impedance matching), the concave focusing head 31 is concentrically arranged with the diffraction-focused acoustic lens 4, and the diffraction-focused acoustic lens 4 is fixedly connected to the ultrasonic transducer 2 through connecting rods 401. The diffraction-focused acoustic lens 4 includes alternating transparent rings 41 and opaque rings 42 arranged concentrically.

A working principle of the ultrasonic generator (also referred to as the ultrasonic power supply) is to convert electrical energy into mechanical energy through a specific energy conversion mechanism. The ultrasonic transducer is configured to transform electromagnetic energy into mechanical energy (acoustic energy) and to generate ultrasonic waves. The primary function of the focusing amplitude transformer 3 is to amplify the mechanical vibration amplitude generated by the ultrasonic transducer 2 and to effectively transfer the vibrational energy to the molten pool or other processing areas. The design of the diffraction-focused acoustic lens 4 is based on the Fresnel zone plate principle, utilizing the annular structure to modulate the phase of the sound waves, such that the phase difference of the sound waves from each annular zone is zero at the focal point, thereby achieving the focusing of the sound waves.

Compared with traditional focusing acoustic lenses, the diffraction-focused acoustic lens 4 has the following advantages: 1. Simple structure: The design of the diffraction-focused acoustic lens 4 is based on the Fresnel zone plate principle, and its structure usually consists of a series of concentric circular rings or annular zones. Compared with traditional refractive or reflective acoustic lenses, its structure is simpler and the difficulty of manufacturing is reduced. 2. Thinner axial thickness: Since the diffraction-focused acoustic lens 4 achieves focusing through the principle of diffraction and does not rely on the refractive index difference of materials like refractive lenses, its axial thickness can be thinner. This is conducive to miniaturization and integration. 3. Wideband characteristics: The design of the diffraction-focused acoustic lens 4 can be adjusted by changing the width and spacing of the annular zones to adapt to sound waves of different frequencies. Therefore, it can maintain good focusing effects over a wide frequency range and has a broader application range compared with traditional lenses. 4. Significant sound pressure amplification: The diffraction-focused acoustic lens 4 can effectively focus the energy of sound waves to a point or a small area, achieving significant amplification of sound pressure. 5. Wide applicable frequency range: Since it is based on the principle of diffraction, the diffraction-focused acoustic lens 4 is not limited by the refractive index of materials and can be used in a wide frequency range from low to high frequencies to meet the needs of different application scenarios. 6. Low cost: With advanced manufacturing technologies (such as 3D printing, i.e., three-dimensional printing), the diffraction-focused acoustic lens 4 can be mass-produced, thereby reducing manufacturing costs and facilitating its promotion and application. 7. Reduced transmission loss: Compared with traditional refractive acoustic lenses, the diffraction-focused acoustic lens 4 has less absorption of sound waves during the process of converging sound waves. Therefore, it can reduce transmission loss and improve energy utilization efficiency. 8. Easy to optimize design: The annular structure and dimensions of the diffraction-focused acoustic lens 4 can be conveniently adjusted to achieve the best focusing effect and sound pressure amplification ratio.

Each of the multi-degree-of-freedom variable-angle clamping mechanisms 40 includes a three-directional displacement platform, an angle adjustment unit arranged on an output end of the three-directional displacement platform, and a clamp ring 22 connected to an output end of the angle adjustment unit. The clamp ring 22 is engaged with an outer wall of an ultrasonic transducer 2. The three-directional displacement platform includes an X-direction adjustment assembly 7, a Y-direction adjustment assembly 6, and a Z-direction adjustment assembly 8 connected in sequence in that order, and each of the X-direction adjustment assembly 7, the Y-direction adjustment assembly 6, and the Z-direction adjustment assembly 8 includes a base 82 and a slide plate 81 slidably mounted on the base 82; a rack 83 is fixedly mounted on a side of the base 82 facing towards the slide plate 81, a displacement adjustment gear 84 meshing with the rack 83 is rotatably mounted on the slide plate 81, a shaft 85 of the displacement adjustment gear 84 is connected to a displacement adjustment handwheel 86 rotatably mounted on the slide plate 81, and the slide plate 81 is positioned and connected to the base 82 through a positioning bolt 77. The base 72 of the X-direction adjustment assembly 7 is connected to the laser cladding mechanism 5 through a connecting plate 78, and the slide plate 71 of the Z-direction adjustment assembly 8 is connected to the angle adjustment unit. For the X-direction adjustment assembly 7, the slide plate 71, the base 72, the rack 73, the displacement adjustment gear 74, the shaft 75, the displacement adjustment handwheel 76, and the positioning bolt 77 are arranged in the same manner as the Z-direction adjustment assembly 8. For the Y-direction adjustment assembly 6, the slide plate 61, the base 62, the rack 63, the displacement adjustment gear 64, the shaft 65, the displacement adjustment handwheel 66, and the positioning bolt 77 are arranged in the same manner as the Z-direction adjustment assembly 8.

By setting up the three-directional displacement platform, the distance between the ultrasonic vibration mechanism and a molten pool can be adjusted to achieve effective coupling between the ultrasonic vibration and the molten pool, thereby making the application of ultrasonic more uniform.

The angle adjustment unit includes a pitch angle adjustment assembly 9 and a horizontal angle adjustment assembly 10. The pitch angle adjustment assembly 9 includes a pitch angle adjustment gear 17 vertically rotatably mounted on the slide plate 81 of the Z-direction adjustment assembly 8 and a pitch angle adjustment handwheel 18 meshing with the pitch angle adjustment gear 17, the pitch angle adjustment handwheel 18 is rotatably mounted on a regulating plate 20, and an end of the regulating plate 20 facing towards the slide plate 81 of the Z-direction adjustment assembly 8 is fixed with a slide head 201. The slide head 201 is slidably connected to an arc-shaped slide slot 801 defined on the slide plate 81 of the Z-direction adjustment assembly 8, and the arc-shaped slide slot 801 is concentrically arranged with the pitch angle adjustment gear 17. The horizontal angle adjustment assembly 10 includes a horizontal angle adjustment handwheel 19 rotatably mounted on the regulating plate 20, the horizontal angle adjustment handwheel 19 is penetrated into an interior of the regulating plate 20 and is connected with a worm wheel 24, the worm wheel 24 meshes with an end of a worm shaft 21 rotatably mounted inside the regulating plate, and another end of the worm shaft 21 is fixedly connected with the clamp ring 22. The regulating plate 20 and the slide plate 81 of the Z-direction adjustment assembly 8, as well as the worm shaft 21 and the regulating plate 20 are positioned and connected through positioning set screws 25.

The multi-degree-of-freedom ultrasonic-assisted laser cladding remanufacturing device further includes a cooling mechanism 50. The cooling mechanism 50 includes a cooling water tank 51 and a circulation pump 52, an outlet pipe 53 of the cooling water tank 51 is connected to the circulation pump 52, and a heat exchange tube 54 is connected to the circulation pump 52 and in contact with the ultrasonic transducer 2 of each of the focused ultrasonic vibration mechanism 30 and the laser cladding mechanism 5, individually, and the heat exchange tube 54 is further connected to the circulation pump 52 through a return water port 55. The heat exchange tube 54 is connected to a water cooling plate 23 attached onto the diffraction-focused acoustic lens 4 through a water pipe, the water cooling plate 23 is a structure of multi-layer annular water-cooled coils 232, with adjacent layers of the multi-layer annular water-cooled coils 232 are connected by communication pipes 231, and the multi-layer annular water-cooled coils 232 are fixedly connected to a side of the opaque rings 42 of the diffraction-focused acoustic lens 4 facing towards the cladding zone. The multi-layer annular water-cooled coils 232 are concentrically arranged with the diffraction-focused acoustic lens 4, and an inner diameter of an innermost layer of annular water-cooled coil of the multi-layer annular water-cooled coils 232 is not less than a lowest diffraction radius of the diffraction-focused acoustic lens.

A material of the transparent rings 41 of the diffraction-focused acoustic lens 4 is polyimide.

The positioning mechanism includes positioning cylinders 11 arranged around the workpiece to be processed 12, and positions of the positioning cylinders 11 facing towards the workpiece to be processed 12 are fixed with positioning plates, respectively.

A working method of the multi-degree-of-freedom ultrasonic-assisted laser cladding remanufacturing device includes steps S1 to S3 as follows.

S1, loading: the workpiece to be processed is placed on the worktable, and the positioning cylinders are activated to drive the positioning plates to hold edges of the workpiece to be processed.

S2, position adjusting: the displacement adjustment gears on the X-direction adjustment assembly, the Y-direction adjustment assembly and the Z-direction adjustment assembly are sequentially rotated, under meshing actions with the respective racks, to drive the slide plates of the X-direction adjustment assembly, the Y-direction adjustment assembly and the Z-direction adjustment assembly to slide along the respective bases of the X-direction adjustment assembly, the Y-direction adjustment assembly, and the Z-direction adjustment assembly, thereby adjusting a position of the ultrasonic transducer of each of the focused ultrasonic vibration mechanism to make two the ultrasonic transducers be symmetrical about the laser cladding mechanism. Then, the positioning bolts are used to position current position of the ultrasonic transducer. Afterwards, the pitch angle adjustment handwheel is rotated to drive the regulating plate to rotate around the pitch angle adjustment gear, thereby adjusting a pitch angle of the ultrasonic transducer. Next, the horizontal angle adjustment handwheel is rotated to drive the ultrasonic transducer to rotate under an action of the worm wheel and the worm shaft, thereby ensuring that the ultrasonic waves emitted by the ultrasonic transducer, after being amplified by the focusing amplitude transformer, propagate towards a center of the diffraction-focused acoustic lens to thereby be focused onto the cladding zone by the diffraction-focused acoustic lens. Finally, the positioning set screws are used to position a current position of the ultrasonic transducer.

S3, the circulation pumps of the cooling mechanism 50 and the laser cladding mechanism are sequentially activated to simultaneously cool the ultrasonic transducers, the laser cladding mechanism, and the diffraction-focused acoustic lenses with cooling water. In this embodiment, temperature sensors can also be used to collect real-time operating temperatures of various components, thereby adjusting the outlet temperature of the cooling water and maintaining stable operating temperatures. The laser cladding mechanism is activated, a laser emitted is aimed by a laser cladding head of the laser cladding mechanism at the cladding zone, and powder supplied by a powder feeder of the laser cladding mechanism is delivered to the cladding zone. The powder is melted under a combined action of the laser and ultrasonic assistance and the cladding zone of the workpiece to be processed is covered.

In step S3, a robotic arm or other displacement mechanism can be used to move the laser cladding mechanism 5 and the ultrasonic transducer 2 synchronously, thereby achieving processing along a specific path.

### Experiment

### 1. Preparation Before Debugging

(1) Material preparation: a thin polydimethylsiloxane film (PDMS film) for testing the intensity of focused ultrasound is prepared. Simultaneously, an appropriate amount of metal powder for adjusting the focusing position and angle is prepared.
(2) Environment setup: clean working environment and free of other interfering factors are ensured, thereby to accurately observe and record the debugging results. The shooting angle and focus of the infrared camera or thermal camera are adjusted to accurately capture the temperature changes of the PDMS film.

### 2. Debugging the Laser Cladding Mechanism and the Ultrasonic Vibration Mechanisms

(1) Preliminary focusing: the infrared generator at the nozzle of the laser cladding head of the laser cladding mechanism is used, the infrared light emitted by the infrared generator is adjusted to form a spot on a substrate, thereby roughly aligning the infrared light with an expected remanufacturing processing position.
(2) The ultrasonic transducers are installed on the multi-degree-of-freedom variable-angle clamping mechanisms through the clamp rings, respectively, and its vibration frequency and power are initially set.
(3) A position and an angle of the ultrasonic vibration mechanism are adjusted by using the handwheel, so that the ultrasonic focus is roughly located in an expected cladding zone.
(4) The PDMS film is placed: the PDMS film is laid flat on the worktable and a stable position of the PDMS film is determined.
(5) Start the equipment: the ultrasonic generators are activated and an initial ultrasonic intensity and an initial ultrasonic frequency are set.
(6) Temperature monitoring: the infrared camera or thermal camera is aimed at the PDMS film and recording its temperature changes is begun.
(7) Parameter adjustment: Based on the temperature changes, the ultrasonic intensity and the ultrasonic frequency are gradually adjusted. The goal is to raise the temperature of the PDMS film from room temperature to 80 degrees Celsius within 20 seconds. When this target is reached, the current ultrasonic intensity and the current ultrasonic frequency parameters are recorded for reference in subsequent remanufacturing processes.
(8) Material replacement: the PDMS film is removed and a layer of metal powder (1 mm thick) is evenly spread on the substrate, and the previously set ultrasonic intensity is maintained.
(9) Position adjustment: adjusting the position of the ultrasonic vibration mechanism (i.e., the distance between the diffraction-focused acoustic lens and the metal powder layer) is begun. The distance is gradually reduced and the changes in the metal powder layer under the influence of ultrasound are observed. When the powder layer starts to show slight indentations, it indicates that the focusing effect is beginning to take place.
(10) Angle adjustment: At the same time, the angle of the ultrasonic vibration mechanism is adjusted so that its ultrasonic focus coincides with the spot, it is ensured that both of the ultrasonic focus and the spot can accurately act on the same area. The angle is fine-tuned and the changes in the powder layer's indentations are observed to find the optimal focusing effect.
(11) Repeated debugging: the position and the angle are repeatedly adjusted to determine the focus that causes the maximum indentation in the metal powder layer, and the position parameters and the angle parameters are recorded at this time.

### 3. Laser Cladding Remanufacturing

(1) Surface treatment of the workpiece to be processed: the surface of the workpiece to be processed is cleaned by using an appropriate cleaning agent or solvent to remove oil, rust, and other impurities. Mechanical processing is performed on the cleaned workpiece to be processed to remove an oxide layer from the surface to be remanufactured. Then, the surface is roughened by sandblasting to reduce laser reflectivity, followed by cleaning and drying.
(2) Fixing the workpiece: the workpiece to be processed is secured to ensure that it does not move or shake during the processing.
(3) Pre-setting the laser path and setting processing parameters: the area to be remanufactured is planned according to the size parameters and performance requirements of the workpiece surface to be remanufactured.
(4) Parameter setting: the processing parameters are set, including laser power, cladding speed, powder feeding rate, etc.
(5) Start ultrasonic and laser cladding: The laser generator uses a fiber laser. The laser cladding head is aimed at the starting point of the area to be clad (argon gas is used as the powder feeding gas and protective gas during the remanufacturing process to prevent oxidation).
(6) Start ultrasonic: First, the ultrasonic vibration mechanism is started to ensure that it is working properly and generating stable ultrasonic waves, then the ultrasonic vibration mechanism is adjusted to the previously debugged ultrasonic intensity and frequency parameters.
(7) Start laser: a synchronous powder feeder and a fiber laser are turned on through the control console. The laser cladding head begins to scan along a preset path. The laser cladding head and ultrasonic vibration mechanism move synchronously to ensure that a laser beam and the ultrasonic vibration focus are at the same position in the area to be clad. During the movement, the synchronous powder feeder delivers powder to the coaxial powder feeding nozzle of the laser. The powder is sprayed out from the lower end of the coaxial powder feeding nozzle of the laser and is melted by the laser, covering the cladding zone. At the same time, the ultrasonic vibration mechanism continuously applies ultrasonic assistance to the molten pool.

During the processing, the working status of the laser cladding head and the ultrasonic vibration mechanism are closely monitored to ensure that they can move synchronously and accurately act on the same area.

Monitoring and adjustment during the remanufacturing process: When repairing and remanufacturing small-sized parts, continuous operation can be performed. When remanufacturing large-sized parts, it is necessary to monitor the temperature of the focused ultrasonic vibration head. An interlayer pause strategy should be adopted (that is, pause the processing process, wait for the temperature to decrease or the parameters to be adjusted before continuing the processing, which helps to ensure processing quality and equipment safety), to ensure that the focused ultrasonic head works within an appropriate temperature range. And according to the actual situation during the processing, a laser power, a cladding speed, a powder feeding rate and other parameters are adjusted in time. For example, when cracks or pores are found in the cladding layer, the cladding speed can be appropriately reduced, the powder feeding rate increased, and the frequency and amplitude of ultrasonic vibration adjusted to improve the cladding quality.

### 4. End of Processing and Subsequent Treatment

(1) Shut down the equipment: After the process of laser cladding remanufacturing is completed, first the ultrasonic vibration mechanism and the laser cladding mechanism are turned off, and then the cooling mechanism is shut down.
(2) Cooling treatment: the workpiece is allowed to cool down to room temperature naturally before removing the processed workpiece, thereby to avoid taking out the workpiece directly at high temperature to prevent deformation or burns.
(3) Post-processing: necessary post-processing is performed on the processed workpiece (such as grinding, polishing, etc.) to remove surface defects and enhance its service performance.

In the disclosure, experimental data are as follows.

Test Conditions: substrate: 45 steel, dimensions 60×100×10 mm³; cladding material: 20Cr13 alloy powder (particle size 50-150 μm); laser power: 4 kW, spot diameter 3 mm; ultrasonic frequency: 20 kHz, amplitude 35 μm; ambient temperature: 25±2° C., humidity 50±5%.

TABLE 1
Comparison of Cladding Layer Properties (comparison
between traditional process and the disclosure)

| | | Test | The | Improvement |
|---|---|---|---|---|
| Test Item | Test Method | Method | disclosure | Effect |
| Porosity (%) | Metallographic microscope | 1.2 ± 0.3 | 0.3 ± 0.1 | Reduced by |
| | (ASTM E1245) | | | 75% |
| Residual Stress | X-ray diffraction (ASTM E915) | 240 ± 40 | 92.6 ± 15 | Reduced by |
| (MPa) | | | | 61.4% |
| Grain Size (μm) | Scanning electron microscope | 20 ± 5 | 5 ± 1 | Refined by |
| | (SEM, ISO 13383) | | | 75% |
| Surface Roughness | White light interferometer | 6.5 ± 0.8 | 3.6 ± 0.4 | Reduced by |
| Ra (μm) | (ISO 4287) | | | 44.6% |
| Heat-Affected Zone | Microhardness gradient test | 0.5 ± 0.1 | 0.2 ± 0.05 | Reduced by |
| Depth (mm) | (HV0.5) | | | 60% |

TABLE 2
Validation of Symmetric Multi-degree-of-freedom
Ultrasonic Vibration Mechanism Effects

| | Porosity | Grain Size | Cladding Layer |
|---|---|---|---|
| Test Condition | (%) | (μm) | Uniformity (μm) |
| Without ultrasonic | 2.5 ± 0.5 | 30 ± 8 | ±25 |
| assistance | | | |
| Single-side ultrasonic | 1.2 ± 0.3 | 20 ± 5 | ±15 |
| vibration | | | |
| The disclosure (symmetric | 0.3 ± 0.1 | 5 ± 1 | ±5 |
| ultrasonic) | | | |

TABLE 3
Coupling Effect of Diffraction-focused
Acoustic Lens and Amplitude Transformer

| | Single | Amplitude | |
|---|---|---|---|
| | Amplitude | Transformer + | |
| | Transformer | Diffraction | Improvement |
| Parameter | (No Lens) | Lens | Effect |
| Acoustic pressure at | 1.2 ± 0.2 | 2.5 ± 0.3 | Increased by |
| focus (MPa) | | | 108% |
| Acoustic energy transfer | 45 ± 5 | 78 ± 5 | Increased by |
| efficiency (%) | | | 73.3% |
| Acoustic field coverage | 5.0 ± 0.5 | 12.5 ± 1.0 | Increased by |
| area (mm²) | | | 150% |

TABLE 4
Precision Test of Multi-degree-of-freedom Adjustment Mechanism

| | Adjustment | Positioning | Angular |
|---|---|---|---|
| Adjustment Dimension | Range | Accuracy | Deviation (°) |
| X/Y/Z-axis displacement | 0-400 | ±0.1 mm | — |
| (mm) | | | |
| Pitch angle (°) | 0-90 | ±0.1° | <0.05° |
| Horizontal angle (°) | 0-360 | ±0.2° | <0.1° |

It can be concluded that the disclosure employs two sets of ultrasonic vibration mechanisms to form a constructive interference acoustic field in the molten pool region. The acoustic pressure intensity is increased to 1.8 times that of single-side excitation, significantly enhancing the stirring effect within the molten pool. Simultaneously, through X/Y/Z-axis displacement (accuracy ±0.1 mm) and pitch/horizontal angle adjustments, real-time alignment of the ultrasonic focus with molten pool deformation is achieved, reducing the residual stress in the cladding layer to 92.6 MPa (compared to 240 MPa with the traditional process). Consequently, porosity is reduced by 75% (from 1.20% to 0.30%), and the grain size is refined to 5 μm (compared to 20 μm with the traditional process), demonstrating the inventiveness of the disclosure.

Finally, it should be noted that the above embodiments are only used to illustrate the technical solution of the disclosure and not to limit it. Although the disclosure has been described in detail with reference to the preferred embodiments, those skilled in the art should understand that modifications or equivalent substitutions can still be made to the technical solution of the disclosure, and these modifications or equivalent substitutions cannot make the modified technical solution deviate from the spirit and scope of the technical solution of the disclosure.

1. A multi-degree-of-freedom ultrasonic-assisted laser cladding remanufacturing device, comprising:
a worktable, a workpiece to be processed configured to be disposed on a top end of the worktable by a positioning mechanism, a laser cladding mechanism disposed above the workpiece to be processed, and focused ultrasonic vibration mechanisms symmetrically arranged on two sides of the laser cladding mechanism by multi-degree-of-freedom variable-angle clamping mechanisms; the focused ultrasonic vibration mechanisms being configured to emit focused ultrasonic waves aligned with a cladding zone of the laser cladding mechanism;
wherein each of the multi-degree-of-freedom variable-angle clamping mechanisms comprises a three-directional displacement platform, an angle adjustment unit arranged on an output end of the three-directional displacement platform, and a clamp ring connected to an output end of the angle adjustment unit; and the clamp ring is engaged with an outer wall of an ultrasonic transducer;
wherein each of the focused ultrasonic vibration mechanisms comprises an ultrasonic generator, the ultrasonic transducer, a focusing amplitude transformer, and a diffraction-focused acoustic lens sequentially arranged in that order; the ultrasonic generator is electrically connected to the ultrasonic transducer, an emitting end of the ultrasonic transducer is aligned with an end of the focusing amplitude transformer, another end of the focusing amplitude transformer is configured as a concave focusing head, the concave focusing head is concentrically arranged with the diffraction-focused acoustic lens, and the diffraction-focused acoustic lens is fixedly connected to the ultrasonic transducer through connecting rods;
wherein the diffraction-focused acoustic lens comprises alternating and concentrically arranged transparent rings and opaque rings;
wherein a material of the transparent rings of the diffraction-focused acoustic lens is polyimide.

2. The multi-degree-of-freedom ultrasonic-assisted laser cladding remanufacturing device as claimed in claim 1, wherein the three-directional displacement platform comprises an X-direction adjustment assembly, a Y-direction adjustment assembly, and a Z-direction adjustment assembly connected in sequence in that order; each of the X-direction adjustment assembly, the Y-direction adjustment assembly, and the Z-direction adjustment assembly comprises a base and a slide plate slidably mounted on the base; a rack is fixedly mounted on a side of the base facing towards the slide plate, a displacement adjustment gear meshing with the rack is rotatably mounted on the slide plate, a shaft of the displacement adjustment gear is connected to a displacement adjustment handwheel rotatably mounted on the slide plate, and the slide plate is positioned and connected to the base through a positioning bolt;
wherein the base of the X-direction adjustment assembly is connected to the laser cladding mechanism through a connecting plate, and the slide plate of the Z-direction adjustment assembly is connected to the angle adjustment unit.

3. The multi-degree-of-freedom ultrasonic-assisted laser cladding remanufacturing device as claimed in claim 2, wherein the angle adjustment unit comprises a pitch angle adjustment assembly and a horizontal angle adjustment assembly; the pitch angle adjustment assembly comprises a pitch angle adjustment gear vertically rotatably mounted on the slide plate of the Z-direction adjustment assembly, and a pitch angle adjustment handwheel meshing with the pitch angle adjustment gear; the pitch angle adjustment handwheel is rotatably mounted on a regulating plate, and an end of the regulating plate facing towards the slide plate of the Z-direction adjustment assembly is fixed with a slide head; the slide head is slidably connected to an arc-shaped slide slot defined on the slide plate of the Z-direction adjustment assembly, and the arc-shaped slide slot is concentrically arranged with the pitch angle adjustment gear;
wherein the horizontal angle adjustment assembly comprises a horizontal angle adjustment handwheel rotatably mounted on the regulating plate, the horizontal angle adjustment handwheel is penetrated into an interior of the regulating plate and connected with a worm wheel, the worm wheel meshes with an end of a worm shaft rotatably mounted inside the regulating plate, and another end of the worm shaft is fixedly connected with the clamp ring;
wherein the regulating plate and the slide plate of the Z-direction adjustment assembly, as well as the worm shaft and the regulating plate, are positioned and connected through positioning set screws.

4. The multi-degree-of-freedom ultrasonic-assisted laser cladding remanufacturing device as claimed in claim 3, further comprising a cooling mechanism, wherein the cooling mechanism comprises a cooling water tank and a circulation pump, an outlet pipe of the cooling water tank is connected to the circulation pump, a heat exchange tube is connected to the circulation pump and in contact with the ultrasonic transducer of each of the focused ultrasonic vibration mechanism and the laser cladding mechanism individually, and the heat exchange tube is further connected to the circulation pump through a return water port.

5. The multi-degree-of-freedom ultrasonic-assisted laser cladding remanufacturing device as claimed in claim 4, wherein the heat exchange tube is connected to a water cooling plate attached onto the diffraction-focused acoustic lens through a water pipe; the water cooling plate is a structure of multi-layer annular water-cooled coils, with adjacent layers of annular water-cooled coils are connected by communication pipes, and the annular water-cooled coils are fixedly connected to a side of the opaque rings of the diffraction-focused acoustic lens facing towards the cladding zone;
wherein the multi-layer annular water-cooled coils are concentrically arranged with the diffraction-focused acoustic lens, and an inner diameter of an innermost layer of annular water-cooled coil of the multi-layer annular water-cooled coils is not less than a lowest diffraction radius of the diffraction-focused acoustic lens.

6. The multi-degree-of-freedom ultrasonic-assisted laser cladding remanufacturing device as claimed in claim 5, wherein the positioning mechanism comprises positioning cylinders arranged around the workpiece to be processed, and positions of the positioning cylinders facing towards the workpiece to be processed are fixed with positioning plates, respectively.

7. A working method of the multi-degree-of-freedom ultrasonic-assisted laser cladding remanufacturing device as claimed in claim 6, comprising:
S1, loading, comprising: placing the workpiece to be processed on the worktable, and activating the positioning cylinders to drive the positioning plates to hold edges of the workpiece to be processed;
S2, position adjusting, comprising: sequentially rotating the displacement adjustment gears on the X-direction adjustment assembly, the Y-direction adjustment assembly and the Z-direction adjustment assembly, under meshing actions with the respective racks, to drive the slide plates of the X-direction adjustment assembly, the Y-direction adjustment assembly and the Z-direction adjustment assembly to slide along the respective bases of the X-direction adjustment assembly, the Y-direction adjustment assembly and the Z-direction adjustment assembly, thereby adjusting a position of the ultrasonic transducer of each of the focused ultrasonic vibration mechanism to make two the ultrasonic transducers be symmetrical about the laser cladding mechanism; then, using the positioning bolts to position current position of the ultrasonic transducer; afterwards, rotating the pitch angle adjustment handwheel to drive the regulating plate to rotate around the pitch angle adjustment gear, thereby adjusting a pitch angle of the ultrasonic transducer; next, rotating the horizontal angle adjustment handwheel to drive the ultrasonic transducer to rotate under an action of the worm wheel and the worm shaft, thereby ensuring that the ultrasonic waves emitted by the ultrasonic transducer, after being amplified by the focusing amplitude transformer, propagate towards a center of the diffraction-focused acoustic lens to thereby be focused onto the cladding zone by the diffraction-focused acoustic lens; finally, using the positioning set screws to position current position of the ultrasonic transducer;
S3, activating the laser cladding mechanism, aiming a laser emitted by a laser cladding head of the laser cladding mechanism at the cladding zone, and delivering powder supplied by a powder feeder of the laser cladding mechanism to the cladding zone; the powder being melt under a combined action of the laser and ultrasonic assistance and covering the cladding zone of the workpiece to be processed; sequentially activating the circulation pump of the cooling mechanism and the laser cladding mechanism to simultaneously cool the ultrasonic transducers, the laser cladding mechanism, and the diffraction-focused acoustic lenses with cooling water.
